(19) United States
(12) Patent Application Publication
(10) Pub. No.: US 2025/0263513 A1
(43) Pub. Date: Aug. 21, 2025

(54) PVP COMB COPOLYMER AND PREPARATION METHOD THEREFOR AND USE THEREOF

(71) Applicant: SHANGHAI YUKING WATER SOLUBLE MATERIAL TECH CO., LTD., Pudong New Area, Shanghai (CN)

(72) Inventors: Yu Wang, Shanghai (CN); Guangdong Zhu, Shanghai (CN); Yongjiang Guo, Shanghai (CN); Feng Wu, Shanghai (CN); Bing Zang, Shanghai (CN); Zhan Chen, Shanghai (CN)

(73) Assignee: SHANGHAI YUKING WATER SOLUBLE MATERIAL TECH CO., LTD., Pudong New Area, Shanghai (CN)

(21) Appl. No.: 18/858,598

(22) PCT Filed: Jun. 30, 2023
(86) PCT No.: PCT/CN2023/105051

§ 371 Date: Oct. 21, 2024

(30) Foreign Application Priority Data
Dec. 31, 2022 (CN) 202211739009.5

(51) Int. Cl. C08F 290/04; C08K 3/04

(52) U.S. Cl. CPC C08F 290/04; C08K 3/041; C08K 2201/011

(57) ABSTRACT

Disclosed are a PVP comb-like copolymer and a preparation method therefor and a use thereof. The preparation method comprises: (1) preparation of PVP-OH copolymer, and (2) preparation of PVP comb-like copolymer. The PVP comb-like copolymer prepared from the preparation method has a homogeneous structure. A carbon nanotube slurry prepared by using the PVP comb copolymer as a dispersant has the characteristics of high dispersion efficiency, good stability, and short dispersion period.

### TECHNICAL FIELD

Embodiments of the present application relate to the technical fields of new materials and chemical engineering, for example, a PVP comb-like copolymer, a preparation method therefor, and an application thereof.

### BACKGROUND

Carbon nanotubes, as a new conductive material with excellent electrical conductivity, thermal conductivity, and mechanical properties, have a wide application prospect in the fields of materials, electronic devices, and biology. When carbon nanotubes are used as positive electrode materials, negative electrode materials, or conductive liquids in lithium batteries, the performance of the batteries, including battery capacity, power, cycle life, and heat dissipation performance, can be greatly improved. However, carbon nanotubes are inert and difficult to interact with other substances because of their one-dimensional structure, high length-to-diameter ratio reaching 1000, smooth surface, and lack of functional groups. At the same time, ρ-electrons of carbon atoms form a large range of delocalized π-bonds, and carbon nanotubes tend to be tightly aggregated together by the π-π interaction, which makes them difficult to disperse. Therefore, in order to fully use the excellent characteristics of carbon nanotubes, it is necessary to first make them effectively disperse in the slurry dispersion or material.

At present, the industrialized dispersants of carbon nanotubes are mainly polyvinylpyrrolidone (PVP). PVP can be applied to both the aqueous phase system and organic phase system, and can achieve the effective and stable dispersion of carbon nanotubes. However, the dispersion period of the carbon nanotube slurry using PVP as a dispersant is long, which cannot realize stable dispersion of the slurry while maintaining high dispersion efficiency.

### SUMMARY

The following is a summary of the subject matter that is described in detail herein. This summary is not intended to be limiting as to the scope of the claims.

To solve the above technical problems, embodiments of the present application provide a PVP comb-like copolymer, a preparation method therefor, and an application thereof, which can achieve the effective and stable dispersion of carbon nanotubes, and contribute to excellent slurry stability.

A first object of the present application is to provide a PVP comb-like copolymer having the following structure:

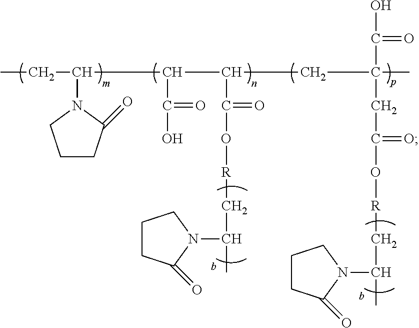

in the structure, 25≤m≤80, n≥0, p≥0, and 15≤n+p≤40, 10≤q≤30, and R is —CH(CH₃)₂— or —C(CH₃)₂O—CH₂—CH₂−.

A second object of the present application is to provide a preparation method for the PVP comb-like copolymer:

### (1) Preparation of PVP-OH Copolymer

under the nitrogen protection, adding a N-vinylpyrrolidone monomer, a chain transfer agent a, an initiator a, and a solvent a to a flask, performing a reaction at a temperature of 60-90° C. for a period of 8-20 h, after the completion of the reaction, removing the solvent and residual monomer by reduced pressure evaporation to obtain the PVP-OH copolymer; and

### (2) Preparation of PVP Comb-Like Copolymer

under the nitrogen protection, adding the N-vinylpyrrolidone monomer and a solvent b to another flask, heating to a temperature of 70-130° C., adding an initial initiator b, and dropwise adding a mixed solution of an anhydride monomer, a chain transfer agent b, and the solvent b for 1-4 h, and after the completion of the dropwise addition, supplementally adding a residue-elimination initiator b, and continuing to hold the temperature for 2-4 h to obtain a mother solution of PVP/anhydride copolymer;
adding the PVP-OH copolymer prepared in the step (1) and a catalyst to the above mother solution of PVP/anhydride copolymer, and supplementally adding an appropriate amount of the solvent b to control an effective substance content of the system to be 40-60%, and heating to 110-140° C., and performing anhydride ring-opening and esterification for 2-7 h, and after the completion of the reaction, subjecting a PVP comb-like copolymer solution obtained to solvent removal under reduced pressure to obtain the PVP comb-like copolymer.

Furthermore, in the step (1), the chain transfer agent a is mercaptoethanol or thioglycerol; the initiator is an azo initiator, comprising azobisisobutyronitrile, 2,2′-azobis(2-methylbutyronitrile), or 2,2′-azo(2-methyl-N-(2-hydroxyethyl)propanamide), preferably 2,2′-azo(2-methyl-N-(2-hydroxyethyl)propanamide) which contains hydroxyl; the solvent a is isopropanol or isopropoxyethanol, preferably isopropoxyethanol, which contains a primary hydroxyl group having a higher hydroxyl activity.

Furthermore, in the step (1), a mass ratio of the N-vinylpyrrolidone to the chain transfer agent a to the initiator a is 100: (2-5): (0.5-2) and a mass ratio of the N-vinylpyrrolidone to the solvent a is 1: (3-10).

Furthermore, in the step (2), the chain transfer agent b is 2,4-diphenyl-4-methyl-1-pentene; the initiator b is an azo initiator or an organic peroxide initiator, the azo initiator is azobisisobutyronitrile, the organic peroxide initiator is benzoyl peroxide, tert-butyl peroxybenzoate, diisopropyl peroxydicarbonate, or dicumyl peroxide, and preferably the initiator b is the azo initiator; the solvent b is an aprotic polar solvent, comprising N-methylpyrrolidone, N,N-dimethyl amide, dimethylsulfoxide, or diethylene glycol dimethyl ether.

Furthermore, in the step (2), the anhydride monomer is one or two of maleic anhydride and itaconic anhydride; the catalyst is p-toluenesulfonic acid, propionic acid, or sulfamic acid.

Furthermore, in the step (2), a mass ratio of the N-vinylpyrrolidone to the anhydride monomer to the chain transfer agent b is 100: (15-35): (0.5-3), and a mass ratio of a total mass of the N-vinylpyrrolidone and the anhydride monomer to the solvent b is 1: (1-3).

Furthermore, in the step (2), an addition amount of the initial initiator b is 0.1-2% of a mass of the N-vinylpyrrolidone, and an addition amount of the residue-elimination initiator b is 0.05-0.5% of a mass of the N-vinylpyrrolidone.

Furthermore, in the step (2), a mass ratio of the PVP-OH copolymer to the anhydride monomer is (10-25): 1; and an addition amount of the catalyst is 0.5-3% of a mass of PVP-OH.

A third object of the present application is to provide an application of the PVP comb-like copolymer in the dispersion of carbon nanotube slurries.

The beneficial effects of embodiments of the present application are as follows:
(1) for the PVP comb-like copolymer in the embodiments of the present application, in the main chain structure, N-vinylpyrrolidone is copolymerized with the anhydride monomer to form a copolymer with a main body of N-vinylpyrrolidone, and by the method of dropwise adding the anhydride monomer, the concentration of the anhydride monomer in the solution is effectively controlled, and thereby an ideal random copolymerization is carried out to form a copolymerization product with a more homogeneous structure;
(2) in terms of the graft component, the PVP comb-like copolymer in the embodiments of the present application uses PVP having a terminal hydroxyl group (PVP-OH) as the graft component, which realizes that the main chain and side chain both have a PVP comb-like structure, so that both the main chain and the side chain can effectively adsorb and disperse carbon nanotubes, and the dispersion and coating can be more complete and more stable; and
(3) the PVP comb-like copolymer in the embodiments of the present application has good applicability to both the aqueous phase system and organic phase system, and the carbon nanotube slurry prepared with the PVP comb-like copolymer as a dispersant has the characteristics of high dispersion efficiency, good stability, and short dispersion period, which can satisfy the application needs of carbon nanotubes in various fields, and the performance in N-methylpyrrolidinone electrode slurry system is particularly outstanding.

Other aspects will be appreciated upon reading and understanding the accompanying drawings and detailed description.

### BRIEF DESCRIPTION OF DRAWINGS

The accompanying drawings are used to provide a further understanding of the technical solutions herein, and form a part of the specification, which are used together with embodiments of the present application to explain the technical solutions herein, and do not constitute a limitation on the technical solutions herein.

FIG. 1 shows an infrared spectrum of the PVP comb-like copolymer prepared in Example 1 of the present application.

### DETAILED DESCRIPTION

The technical solutions in the embodiments of the present application are described clearly and completely below. Obviously, the described embodiments are only some embodiments of the present application but not all embodiments. Based on the embodiments of the present application, other embodiments obtained by a person skilled in the art without creative work shall all fall within the protection scope of the present application.

### Example 1 Preparation of PVP Comb-Like Copolymer 1

### (1) Preparation of a PVP-OH Copolymer

Under the nitrogen protection, 1000 g of N-vinylpyrrolidone, 20 g of mercaptoethanol, 20 g of azodiisobutyronitrile, and 1000 g of isopropanol were added into a flask sequentially, the reaction was performed at a temperature of 60° C. for 20 h, and after completion of the reaction, the solvent and residual monomer were removed by reduced pressure evaporation to obtain the PVP-OH copolymer.

### (2) Preparation of a PVP Comb-Like Copolymer

Under the nitrogen protection, 100 g of N-vinylpyrrolidone and 85 g of N-methylpyrrolidone were added into another flask, and heated to 70° C., then added with 0.1 g of azobisisobutyronitrile as an initial initiator, and dropwise added with a mixed solution of 15 g of maleic anhydride, 3 g of 2,4-diphenyl-4-methyl-1-pentene, and 30 g of N-methylpyrrolidone for a period of 1 h, supplementally added with 0.2 of g azobisisobutyronitrile as a residue-elimination initiator after completion of the dropwise addition, and continuously held at the temperature for 4 h to obtain a mother solution of PVP/anhydride copolymer;

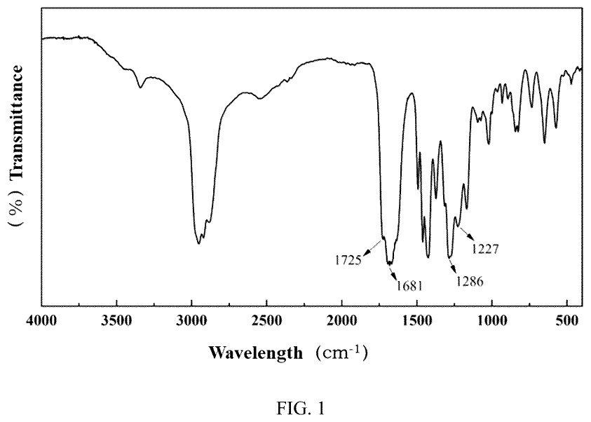

150 g of the PVP-OH copolymer prepared in step (1) and 0.75 g of p-toluenesulfonic acid were added into the above mother solution of PVP/anhydride copolymer, and supplementally added with 62 g of N-methylpyrrolidone, heated to 110° C., and reacted for 5 h for anhydride ring-opening and esterification, and after the completion of the reaction, a PVP comb-like copolymer solution with an effective substance content of 60% was obtained, and the solvent was removed under reduced pressure to obtain the PVP comb-like copolymer 1. The infrared spectrum of the PVP comb-like copolymer is shown in FIG. 1.

### Example 2 Preparation of PVP Comb-Like Copolymer 2

### (1) Preparation of a PVP-OH Copolymer

Under the nitrogen protection, 1000 g of N-vinylpyrrolidone, 35 g of thioglycerol, 20 g of 2,2′-azo(2-methyl-N-(2-hydroxyethyl)propanamide), and 6000 g of isopropoxyethanol were added into a flask sequentially, the reaction was performed at a temperature of 80° C. for 15 h, and after completion of the reaction, the solvent and residual monomer were removed by reduced pressure evaporation to obtain the PVP-OH copolymer.

### (2) Preparation of a PVP Comb-Like Copolymer

Under the nitrogen protection, 100 g of N-vinylpyrrolidone and 200 g of diethylene glycol dimethyl ether were added into another flask, and heated to 100° C., then added with 1 g of benzoyl peroxide as an initial initiator, and dropwise added with a mixed solution of 25 g of itaconic anhydride, 1.5 g of 2,4-diphenyl-4-methyl-1-pentene, and 50 g of diethylene glycol dimethyl ether for a period of 2 h, and supplementally added with 0.5 g of benzoyl peroxide as a residue-elimination initiator after completion of the dropwise addition, continuously held at the temperature for 3 h to obtain a mother solution of PVP/anhydride copolymer;

250 g of the PVP-OH copolymer prepared in step (1) and 7.5 g of propionic acid were added into the above mother solution of PVP/anhydride copolymer, and supplementally added with 125 g of diethylene glycol dimethyl ether, and heated to 140° C., and reacted for 2 h for anhydride ring-opening and esterification, and after the completion of the reaction, a PVP comb-like copolymer solution with an effective substance content of 50% was obtained, and the solvent was removed under reduced pressure to obtain the PVP comb-like copolymer 2.

### Example 3 Preparation of PVP Comb-Like Copolymer 3

### (1) Preparation of a PVP-OH Copolymer

Under the nitrogen protection, 1000 g of N-vinylpyrrolidone, 50 g of mercaptoethanol, 5 g of 2,2′-azo(2-methyl-N-(2-hydroxyethyl)propanamide), and 3000 g of isopropoxyethanol were added into a flask sequentially, the reaction was performed at a temperature of 90° C. for 8 h, and after completion of the reaction, the solvent and residual monomer were removed by reduced pressure evaporation to obtain the PVP-OH copolymer.

### (2) Preparation of a PVP Comb-Llike Copolymer

Under the nitrogen protection, 100 g of N-vinylpyrrolidone and 335 g of N,N-dimethyl amide were added into another flask, and heated to 130° C., added with 2 g of tert-butyl peroxy benzoate as an initial initiator, and dropwise added with a mixed solution of 35 g of itaconic anhydride, 0.5 g of 2,4-diphenyl-4-methyl-1-pentene, and 70 g of N,N-dimethyl amide for a period of 4 h, and supplementally added with 0.05 g of tert-butyl peroxybenzoate as a residue-elimination initiator after completion of the dropwise addition, and continuously held at the temperature for 2 h to obtain a mother solution of PVP/anhydride copolymer;

875 g of the PVP-OH copolymer prepared in step (1) and 13.13 g of sulfamic acid were added into the above mother solution of PVP/anhydride copolymer, and supplementally added with 1110 g of N,N-dimethyl amide, and heated to 130° C., and reacted for 7 h for anhydride ring-opening and esterification, and after the completion of the reaction, a PVP comb-like copolymer solution with an effective substance content of 40% was obtained, and the solvent was removed under reduced pressure to obtain the PVP comb-like copolymer 3.

### Example 4 Preparation of PVP Comb-Like Copolymer 4

### (1) Preparation of a PVP-OH Copolymer

Under the nitrogen protection, 1000 g of N-vinylpyrrolidone, 25 g of mercaptoethanol, 15 g of 2,2′-azo(2-methyl-N-(2-hydroxyethyl)propanamide), and 5000 g of isopropoxyethanol were added into a flask sequentially, the reaction was performed at a temperature of 75° C. for 18 h, and after completion of the reaction, the solvent and residual monomer were removed by reduced pressure evaporation to obtain the PVP-OH copolymer.

### (2) Preparation of a PVP Comb-Like Copolymer

Under the nitrogen protection, 100 g of N-vinylpyrrolidone and 220 g of dimethylsulfoxide were added into another flask, and heated to 110° C., added with 2 g of dicumyl peroxide as an initial initiator, and dropwise added with a mixed solution of 10 g of maleic anhydride, 10 g of itaconic anhydride, 1 g of 2,4-diphenyl-4-methyl-1-pentene, and 80 g of dimethylsulfoxide for a period of 3 h, and supplementally added with 0.25 g of dicumyl peroxide as a residue-elimination initiator after completion of the dropwise addition, and continuously held at the temperature for 3 h to obtain a mother solution of PVP/anhydride copolymer;

300 g of the PVP-OH copolymer prepared in step (1) and 3 g of sulfamic acid were added into the above mother solution of PVP/anhydride copolymer, and supplementally added with 120 g of dimethylsulfoxide, and heated to 125° C., and reacted for 6 h for anhydride ring-opening and esterification, and after the completion of the reaction, a PVP comb-like copolymer solution with an effective substance content of 50% was obtained, and the solvent was removed under reduced pressure to obtain the PVP comb-like copolymer 4.

### Example 5 Preparation of PVP Comb-Like Copolymer 5

### (1) Preparation of a PVP-OH Copolymer

Under the nitrogen protection, 1000 g of N-vinylpyrrolidone, 40 g of thioglycerol, 10 g of 2,2′-azobis(2-methylbutyronitrile), and 8000 g of isopropoxyethanol were added into a flask sequentially, the reaction was performed at a temperature of 85° C. for 12 h, and after completion of the reaction, the solvent and residual monomer were removed by reduced pressure evaporation to obtain the PVP-OH copolymer.

### (2) Preparation of a PVP Comb-Like Copolymer

Under the nitrogen protection, 100 g of N-vinylpyrrolidone and 225 g of N-methylpyrrolidone were added into another flask, and heated to 120° C., then added with 2 g of diisopropyl peroxydicarbonate as an initial initiator, and dropwise added with a mixed solution of 30 g of itaconic anhydride, 2 g of 2,4-diphenyl-4-methyl-1-pentene, and 100 g of N-methylpyrrolidone for a period of 3 h, and supplementally added with 0.3 g of diisopropyl peroxydicarbonate as a residue-elimination initiator after completion of the dropwise addition, and continuously held at the temperature for 4 h to obtain a mother solution of PVP/anhydride copolymer;

600 g of the PVP-OH copolymer prepared in step (1) and 9 g of p-toluenesulfonic acid were added into the above mother solution of PVP/anhydride copolymer, and supplementally added with 405 g of N-methylpyrrolidone, and heated to 135° C., and reacted for 4 h for anhydride ring-opening and esterification, and after the completion of the reaction, a PVP comb-like copolymer solution with an effective substance content of 50% was obtained, and the solvent was removed under reduced pressure to obtain the PVP comb-like copolymer 5.

### Example 6 Application Performance Test

The PVP comb-like copolymers 1-5 prepared in Examples 1-5 were used as a dispersant for dispersing carbon nanotubes in the aqueous phase or the organic phase separately, and after the dispersion, the viscosity of the carbon nanotube slurry was observed, the particle size of the carbon nanotube slurry was detected, and the stability was observed after a period of standing. Meanwhile, PVPK30 and sodium dodecylbenzene sulfonate (SDBS), regular dispersants in the market, were used as the control groups.

Dispersion method: 10 g of carbon nanotubes, 1 g of a dispersant, 250 g of N-methylpyrrolidone (NMP), and 200 g of 0.3 mm zirconium beads were added into a vertical grinding cylinder, and then ground at a rotation speed of 1000 rpm for 1-4 h, and finally, the zirconium beads were filtered off to obtain the carbon nanotube slurry.

The slurry was allowed to stand at room temperature, the viscosity and the appearance of the slurry were observed, and the particle size of the slurry was detected by a laser particle size analyser, and the stability of the slurry was tested by centrifugation in a high-speed centrifuge (10000 r/min, 15 m). The test results are shown in Table 1.

TABLE 1

| | | Grinding | Appearance and | Particle | Centrifugation |
|---|---|---|---|---|---|
| No. | Solvent | period | viscosity | size | stability |
| PVP comb-like | NMP | 1 h | Well-flowable | 336 nm | No precipitate |
| copolymer 1 | | | liquid | | |
| PVP comb-like | NMP | 2 h | Well-flowable | 319 nm | No precipitate |
| copolymer 1 | | | liquid | | |
| PVP comb-like | NMP | 1 h | Well-flowable | 372 nm | No precipitate |
| copolymer 2 | | | liquid | | |
| PVP comb-like | NMP | 1 h | Well-flowable | 316 nm | No precipitate |
| copolymer 3 | | | liquid | | |
| PVP comb-like | NMP | 1 h | Well-flowable | 327 nm | No precipitate |
| copolymer 4 | | | liquid | | |
| PVP comb-like | NMP | 1 h | Well-flowable | 330 nm | No precipitate |
| copolymer 5 | | | liquid | | |
| PVP-K30 | NMP | 4 h | Semi-paste-like | 485 nm | Few |
| | | | liquid | | precipitates |
| PVP comb-like | Water | 1 h | Well-flowable | 396 nm | No precipitate |
| copolymer 1 | | | liquid | | |
| PVP comb-like | Water | 1 h | Well-flowable | 408 nm | No precipitate |
| copolymer 2 | | | liquid | | |
| PVP comb-like | Water | 1 h | Well-flowable | 387 nm | No precipitate |
| copolymer 3 | | | liquid | | |
| PVP comb-like | Water | 1 h | Well-flowable | 394 nm | No precipitate |
| copolymer 4 | | | liquid | | |
| PVP comb-like | Water | 1 h | Well-flowable | 405 nm | No precipitate |
| copolymer 5 | | | liquid | | |
| PVP-K30 | Water | 4 h | Semi-paste-like | 578 nm | Few |
| | | | liquid | | precipitates |
| SDBS | Water | 4 h | Paste-like solid | Small | Significant |
| | | | | particle | precipitates |
| | | | | dispersion | |

As can be seen from the results in Table 1, the carbon nanotube slurries which use PVP comb-like copolymers 1-5 prepared by the methods of Examples 1-5 as dispersants have significantly lower particle sizes and lower viscosities than those of the control groups of SDBS and PVK30 no matter in the aqueous phase or in the organic phase, and furthermore, the grinding period of the slurry preparation is significantly shorter than that of the control groups, the dispersion period is shorter and the dispersion efficiency is high; moreover, after the centrifugation, the carbon nanotube slurries which use PVP comb-like copolymers 1-5 as dispersants still maintain uniform dispersion without visible precipitates, while the carbon nanotube slurries which use SDBS and PVK30 as dispersants all show precipitates no matter in the aqueous phase or in the organic phase. It can be seen that the dispersion performance of the PVP comb-like copolymer in carbon nanotube slurry of the present application is obviously better than that of the conventional dispersants SDBS and PVK30, and the PVP comb-like copolymer of the present application shows high dispersing efficiency and excellent stability of the slurry.

The above is only preferred embodiments of the present application, which is not intended to limit the present application. Any modifications, equivalent replacements, and improvements, which are made within the spirit and principles of the present application, shall be included in the protection scope of the present application.

1. A PVP comb-like copolymer, which has the following structure: 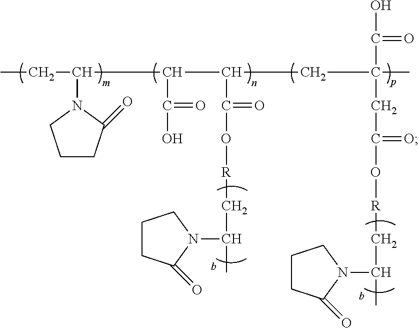
in the structure, 25≤m≤80, n≥0, p≥0, and 15≤n+p≤40, 10≤q≤30, and R is —CH(CH₃)₂— or —C(CH₃)₂—O—CH₂—CH₂—.

2. A preparation method for the PVP comb-like copolymer according to claim 1, which comprises the following steps:
(1) preparation of PVP-OH copolymer
under nitrogen protection, adding a N-vinylpyrrolidone monomer, a chain transfer agent a, an initiator a, and a solvent a to a flask, performing a reaction at a temperature of 60-90° C. for a period of 8-20 h, after the completion of the reaction, removing the solvent and residual monomer by reduced pressure evaporation to obtain the PVP-OH copolymer; and
(2) preparation of PVP comb-like copolymer
under nitrogen protection, adding the N-vinylpyrrolidone monomer and a solvent b to another flask, heating to a temperature of 70-130° C., adding an initial initiator b, and dropwise adding a mixed solution of an anhydride monomer, a chain transfer agent b, and the solvent b for 1-4 h, and after the completion of the dropwise addition, supplementally adding a residue-elimination initiator b, and continuing to hold the temperature for 2-4 h to obtain a mother solution of PVP/anhydride copolymer;
adding the PVP-OH copolymer prepared in the step (1) and a catalyst to the above mother solution of PVP/anhydride copolymer, and supplementally adding an appropriate amount of the solvent b to control an effective substance content of the system to be 40-60%, and heating to 110-140° C., and performing anhydride ring-opening and esterification for 2-7 h, and after the completion of the reaction, subjecting a PVP comb-like copolymer solution obtained to solvent removal under reduced pressure to obtain the PVP comb-like copolymer.

3. The preparation method according to claim 2, wherein in the step (1), the chain transfer agent a is mercaptoethanol or thioglycerol; the initiator a is an azo initiator, comprising azobisisobutyronitrile, 2,2′-azobis(2-methylbutyronitrile), or 2,2′-azo(2-methyl-N-(2-hydroxyethyl)propanamide), preferably 2,2′-azo(2-methyl-N-(2-hydroxyethyl)propanamide) which contains hydroxyl; the solvent a is isopropanol or isopropoxyethanol, preferably isopropoxyethanol.

4. The preparation method according to claim 2, wherein in the step (1), a mass ratio of the N-vinylpyrrolidone to the chain transfer agent a to the initiator a is 100: (2-5): (0.5-2), and a mass ratio of the N-vinylpyrrolidone to the solvent a is 1: (3-10).

5. The preparation method according to claim 2, wherein in the step (2), the chain transfer agent b is 2,4-diphenyl-4-methyl-1-pentene; the initiator b is an azo initiator or an organic peroxide initiator, wherein the azo initiator is azobisisobutyronitrile, and the organic peroxide initiator is benzoyl peroxide, tert-butyl peroxybenzoate, diisopropyl peroxydicarbonate, or dicumyl peroxide, and preferably the initiator b is the azo initiator; the solvent b is an aprotic polar solvent, comprising N-methyl pyrrolidone, N,N-dimethyl amide, dimethylsulfoxide, or diethylene glycol dimethyl ether.

6. The preparation method according to claim 2, wherein in the step (2), the anhydride monomer is one or two of maleic anhydride and itaconic anhydride; the catalyst is p-toluenesulfonic acid, propionic acid, or sulfamic acid.

7. The preparation method according to claim 2, wherein in the step (2), a mass ratio of the N-vinylpyrrolidone to the anhydride monomer to the chain transfer agent b is 100: (15-35): (0.5-3), and a mass ratio of a total mass of the N-vinylpyrrolidone and the anhydride monomer to the solvent b is 1: (1-3).

8. The preparation method according to claim 2, wherein in the step (2), an addition amount of the initial initiator b is 0.1-2% of a mass of the N-vinylpyrrolidone, and an addition amount of the residue-elimination initiator b is 0.05-0.5% of a mass of the N-vinylpyrrolidone.

9. The preparation method according to claim 2, wherein in the step (2), a mass ratio of the PVP-OH copolymer to the anhydride monomer is (10-25): 1; and an addition amount of the catalyst is 0.5-3% of a mass of PVP-OH.

10. (canceled)

11. A method of dispersing carbon nanotube slurries, which uses the PVP comb-like copolymer according to claim 1.
